(19) United States
(12) Patent Application Publication
(10) Pub. No.: US 2002/0109265 A1
(43) Pub. Date: Aug. 15, 2002

(54) Process and apparatus for producing molded articles

(76) Inventors: Rudolf Braungardt, Pechtelsgrun (DE); Erwin Schmucker, Schelklingen (DE)

Correspondence Address: Edmund M. Jaskiewicz, Suite 400, 1730 M Street NW, Washington, DC, 20036, US

(21) Appl. No.: 09/783,360

(22) Filed: Feb. 15, 2001

(51) Int. Cl. B28B 5/00

(52) U.S. Cl. 264/308; 264/334; 425/352; 425/421; 425/422

(57) ABSTRACT

The process produces concrete blocks with different thicknesses of the core concrete and facing concrete in a single mold. To change the height of the core concrete layer and the facing concrete layer, the vertically movable bottom parts of the multichamber mold are first moved into the first vertical position. After the mold is filled with the core concrete the bottom parts together with the core concrete and the lowered pressure plates are moved down into the second vertical position for precompaction. After precompaction, the pressure plates are raised and the mold cavities are filled with the facing concrete. For subsequent finish-compaction the two concrete layers together with the bottom parts and the pressure plates are moved down until the top edge of the bottom parts is at the same height with the bottom edge of the mold. After finish-compaction the bottom parts are moved horizontally to the outside under the mold and finished concrete block is removed from the mold.

### BACKGROUND OF THE INVENTION

The invention relates to a process and an apparatus for producing molded articles, more particularly, concrete blocks from two different material layers which are placed in at least one mold cavity of a vertically movable mold, the mold cavity having substantially vertically movable side walls, a top part which can be closed by a vertically movable pressure plate, and a bottom plate.

Concrete blocks produced using such a process are used, for example, as paving stones which consist essentially of a relatively economical core concrete, whose top portion is coated with a layer of high-quality facing concrete. These paving stones are produced conventionally on a molding machine with a vertically movable mold which is open to the top and bottom and which is seated on a vibrating table. After the mold cavities are filled with the core concrete, the pressure plates corresponding to the mold cavities are lowered until they rest on the core concrete. Subsequently, the pressure plates are raised again and the free space of the mold cavity formed by the precompaction is filled with the facing concrete as far as the upper edge of the mold. Then the pressure plates are lowered again and the two material layers are finish-compacted by revibrating the mold.

The free space formed by the precompaction of the core concrete in the mold cavity determines the height of the top material layer and the thickness of the facing concrete. This height is dependent on the height of the added first material layer and is roughly 10% of the total height of the finished paving stone. For short stones, therefore, the facing concrete layer is relatively thin so that in mechanical working of the stone surface, causes a wearing away or eroding and the core concrete appears. On the other hand, in paving stones with a great total height the facing concrete layer becomes too thick so that increased production costs arise. A further disadvantage is that the production of concrete blocks with different heights in one mold is not possible One special mold is necessary for each stone height.

### SUMMARY OF THE INVENTION

The object of the invention is to improve and make more efficient the production sequence in the manufacture of concrete block with several material layers and different heights in order to reduce production costs thereby.

The objects of the present invention are achieved by the disclosed process for producing paving stones from core concrete, with a top side which has a layer of facing concrete. In order to change the height of the core concrete layer and the facing concrete layer, the vertically movable bottom parts of a multichamber mold are first moved into a first vertical position. After the mold is filled with the core concrete, the bottom parts together with the core concrete and the lowered top pressure plates moved down into a second vertical position for precompaction of the core concrete. After precompaction, the pressure plates are raised and the mold cavities are filled with the facing concrete. For a final compaction, the two concrete layers together with the bottom parts and the pressure plates are moved down until the top edge of the bottom parts is at the same height with the bottom edge of the mold. After final compaction, the bottom parts are moved horizontally to the outside under the mold and the finished concrete block is removed from the mold. Thus, concrete blocks with different thicknesses of the core concrete and facing concrete can be produced in a single mold.

The advantages achieved with the invention are that both different heights of the concrete molded article and also different heights of the individual material layers can be set in the same mold. In this way, for example, in the production of paving stones it is possible to attach the facing concrete layer on the top of the paving stone in any desired thickness. Thus, only a single mold is necessary for production of concrete molded articles with different total heights and with material layers of varying heights. By corresponding program controls the individual operational steps of the production process as disclosed in the invention can be predetermined and can be adjusted according to the desired dimensions of the concrete molded article and the material layers so that a fully automatic production sequence is possible without refitting or modifications in the molding apparatus.

### BRIEF DESCRIPTION OF THE SEVERAL VIEWS OF THE DRAWING

Other objects and advantages of the present invention will be apparent upon reference to the accompanying description when taken in conjunction with the following drawings which are exemplary, wherein;

FIG. 1 is a partially cutaway front view of a molding machine with a mold with bottom parts located in the first vertical position for adding the first material layer.

FIG. 2 is a view similar to that of FIG. 1 showing bottom parts moved into the second vertical position for precompaction of the first material layer.

FIG. 3 is a view similar to that of FIG. 2 with a second material layer added to the mold.

FIG. 4 is a view similar to that of FIG. 3 with the bottom parts moved down into another vertical position for finish-compaction of the material layers.

FIG. 5 is a partially cutaway side view of the molding machine as shown in FIG. 4 with the bottom part moved horizontally out of the area of the mold.

FIG. 6 is a sectional view of the molding machine as shown in Line VI-VI in FIG. 5 and

FIG. 7 is a view similar to that of FIG. 4 with a smaller height of the concrete molded article.

### DETAILED DESCRIPTION OF THE INVENTION

Proceeding next to the drawings wherein like reference symbols indicate the same parts throughout the various views a specific embodiment and modifications of the present invention will be described in detail.

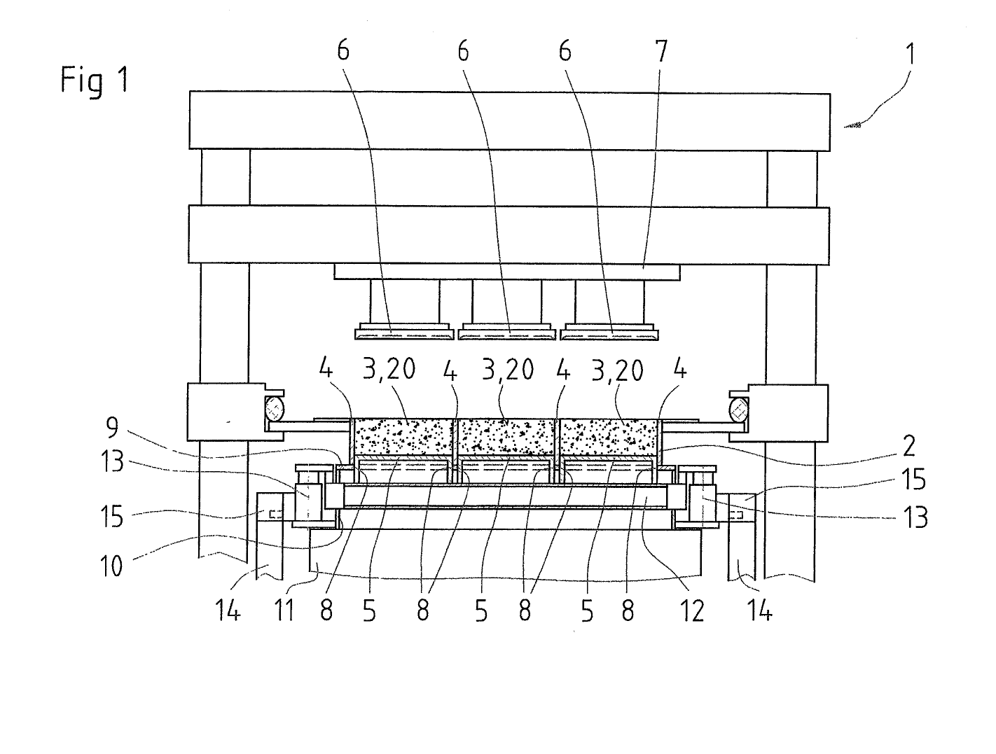

As may be seen in FIG. 1, there is a molding machine indicated generally at 1 which has a vertically movable mold 2 with several mold cavities 3 each of which are bordered by the vertical side walls 4. Bottom plates 5 are assigned to the mold cavities 3 which are open to the bottom and the bottom plates can be retracted in a vertically movable manner from underneath into the respective mold cavity 3 to form a seal. One top pressure plate 6 at a time is assigned to the open top side of the mold cavity 3 and they are arranged on the bottom of a vertically movable holding plate 7.

The bottom plates 5 are movably guided vertically in recesses 8 of a stripper plate 9. The stripper plate 9 forms the top of a box 10 which rests with its open bottom on a vibrating table 11 of the molding machine 1. In other embodiments the box 10 can itself also form the vibrating table. In the box 10 a horizontal support 12 is supported to be able to move vertically and on its top the bottom parts 5 are attached. For the vertical drive of the support 12 it is guided laterally out of the box 10 and is connected to one drive unit 13 at a time, for example, to the ends of the piston rods of the hydraulic cylinders which are attached to the box 10.

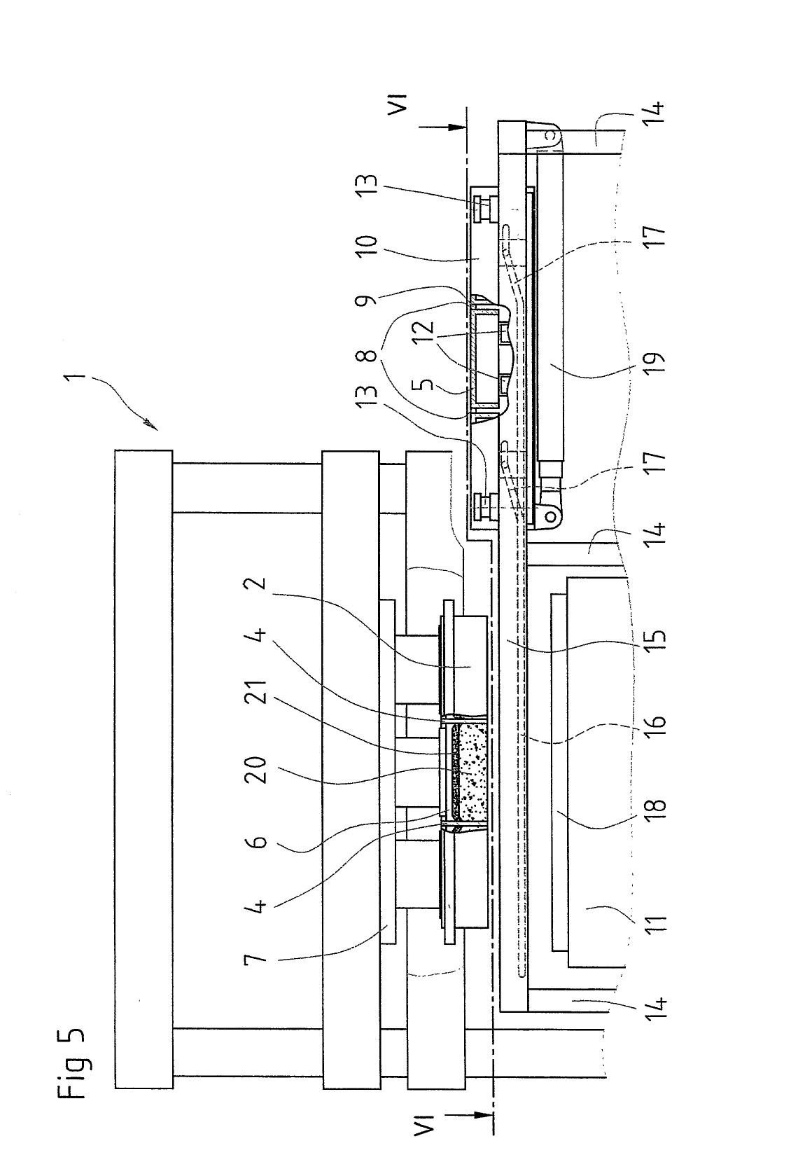

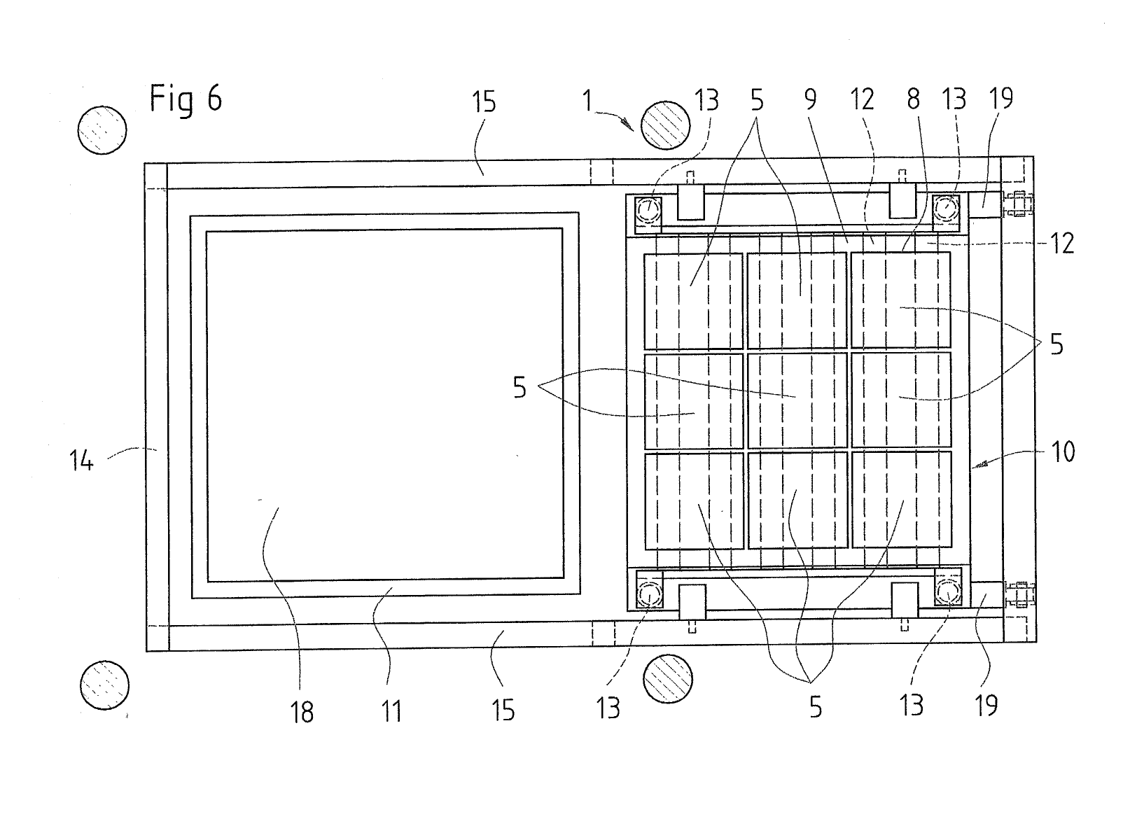

FIGS. 5 and 6 show that the molding machine 1 has a frame 14 with side supports 15 which extend laterally beyond the vibrating table 11. As described above, the box 10 in the guide paths 16 of the supports 15 is supported to be horizontally movable. In this manner the box 10 can be moved horizontally out of the area of the mold 2 and at the end of its horizontal motion, likewise in the conventional manner, it can be raised by the slanted slot guide 17 so far that a frame board 18 for removing the finished concrete blocks can be pushed on to the vibrating table 11. There are two laterally arranged hydraulic cylinders 19 for horizontal drive of the box 10.

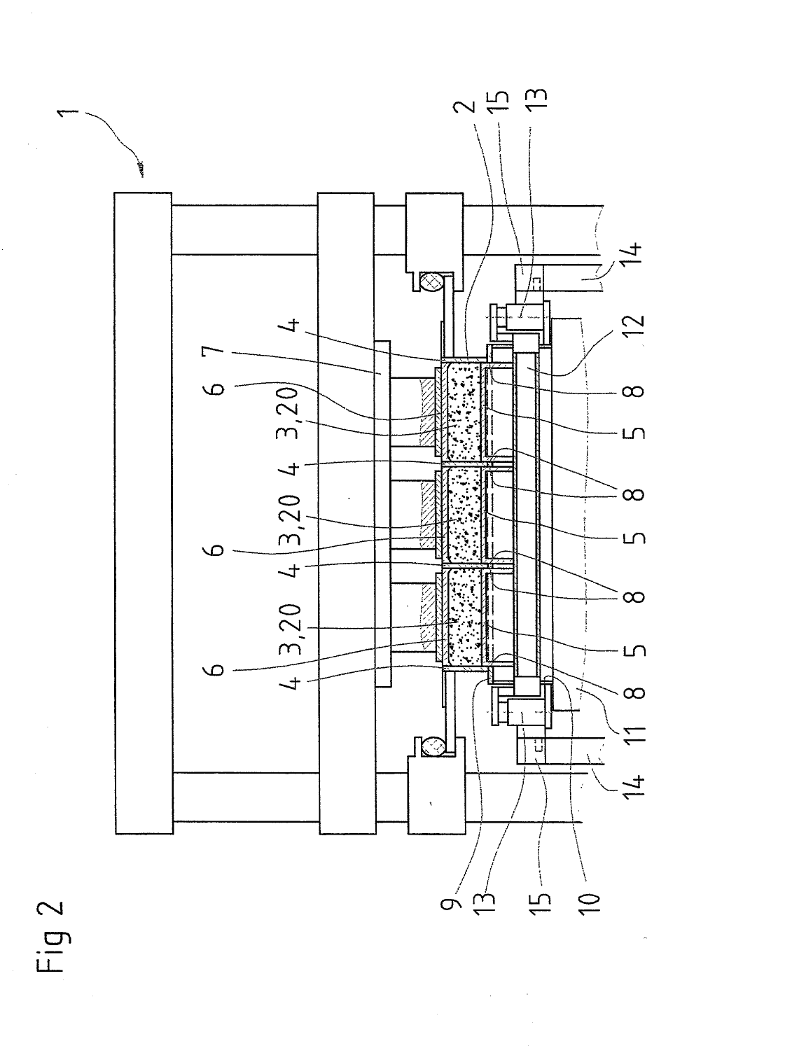

As FIG. 1 shows, first of all the support l2 with the bottom plates 5 is moved up according to the desired stone height into a first vertical position. In doing so the bottom plates 5 dip from underneath into the mold cavities 3 and seal the side walls 4 to the bottom. Then the mold cavities 3 are filled with a first material layer 20 which consists, for example, of core concrete. The holding plate 7 is lowered until the pressure plates 6 rest on the material layer 20. Subsequently, the support 12 with the bottom plates 5 together with the first material layer 20 and the pressure plates 6 is moved down into the second vertical position as shown in FIG. 2. Here the amount by which the bottom plate 5 and the first material layer 20 have been moved down corresponds to the desired height of the second material layer 21 with which the mold cavity 3 is filled after precompaction of the first material layer 20. The first material layer 20 is precompacted by subsequent vibration of the mold 2.

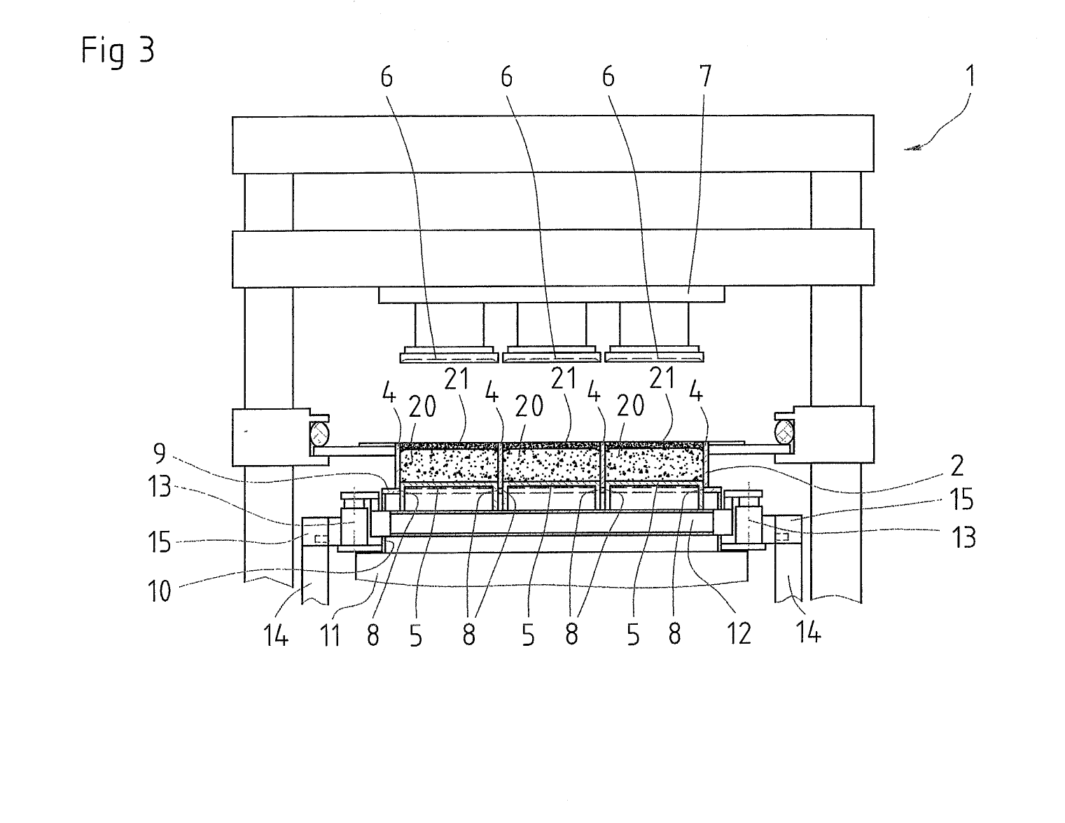

After precompaction, the pressure plates 6 with the holding plate 7 are again moved upward out of the mold cavities 3. The free space in the mold cavities 3 which has been formed by moving down and precompaction is filled with a second material layer 21 which consists, for example, of facing concrete for coating the top of the concrete molded article (FIG. 3). The thickness of the second material layer 21 which corresponds to the distance from the top of the first material layer 20 to the top edge of the mold can be determined by the corresponding choice of the insertion depth of the bottom plates 5 into the mold 2.

Alternatively, the bottom plates 5 can also be moved up or down into the second vertical position only after precompaction of the first material layer 20 which in this case takes place in the first vertical position as shown in FIG. 1. In this position, which corresponds to FIG. 3, then the mold cavity 3 is filled with the second material layer 21. In this way it is possible to move the bottom plates 5 not only down, but also up, since precompaction has already formed a free space in the mold cavity. The size of this free space is reduced when the bottom plates 5 are moved up for example so that the height of the second material 21 with which the free space is then filled can be reduced thereby.

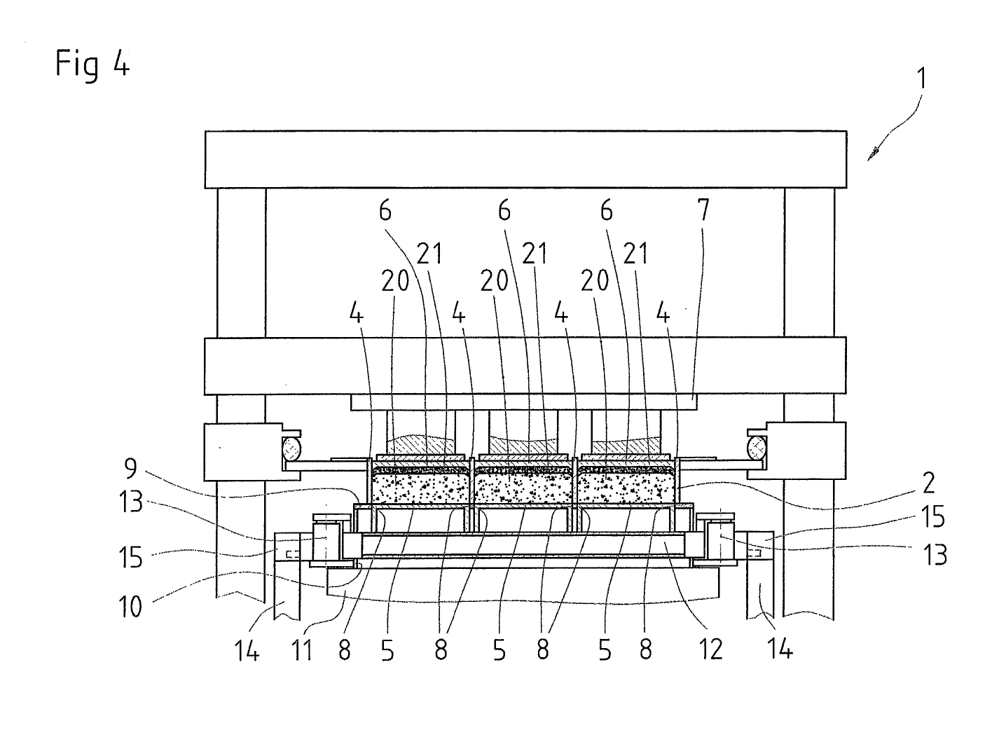

After adding the second material layer 21 the pressure plates 6 are lowered again until they rest on the second material layer 21. By further simultaneous lowering of the pressure plates 6 and the bottom plates 5 the material layers 20 and 21 are moved down relative to the mold 2 until the top edge of the bottom plates 5 is somewhat below the bottom edge of the mold 2 or the material layer 20 (FIG. 4). Concrete residue adhering to the side walls of the bottom plates 5 is stripped off by the stripper plate 9. Then the material layers 20 and 21 are finish-compacted by vibrating the mold 2.

After finish-compaction, the box 10 is moved horizontally to the side by actuating the hydraulic cylinders 19 on the supports 15 until the box is outside the area of the mold 2 (FIGS. 5 and 6). The slanted slot control 17 upon movement out of the mold 2 has raised the box 10 in the conventional manner so far that the frame board 18 could be pushed onto the vibrating table 11. Then the holding plate 7 together with the mold 2 and the material layers 20 and 21 is lowered and the mold 2 is seated on the frame board 18. For subsequent removal from the mold, the mold 2 is raised up in the conventional manner and the finished concrete block is held down by the pressure plates 6 and transported away with the frame board 18.

The invention can also be applied to a modification which is not shown, in which the box 10 itself forms the vibrating table. In this case the box 10 is first moved horizontally by a relatively small amount of roughly 10 cm. in the conventional manner in order to obtain clean separation of the first material layer 20 from the bottom plate 5. At the end of its horizontal movement the box 10 is lowered in the conventional manner, for example, by slanted slot control, so far that the frame board 18 can be pushed between the box 10 and the bottom of the mold 2.

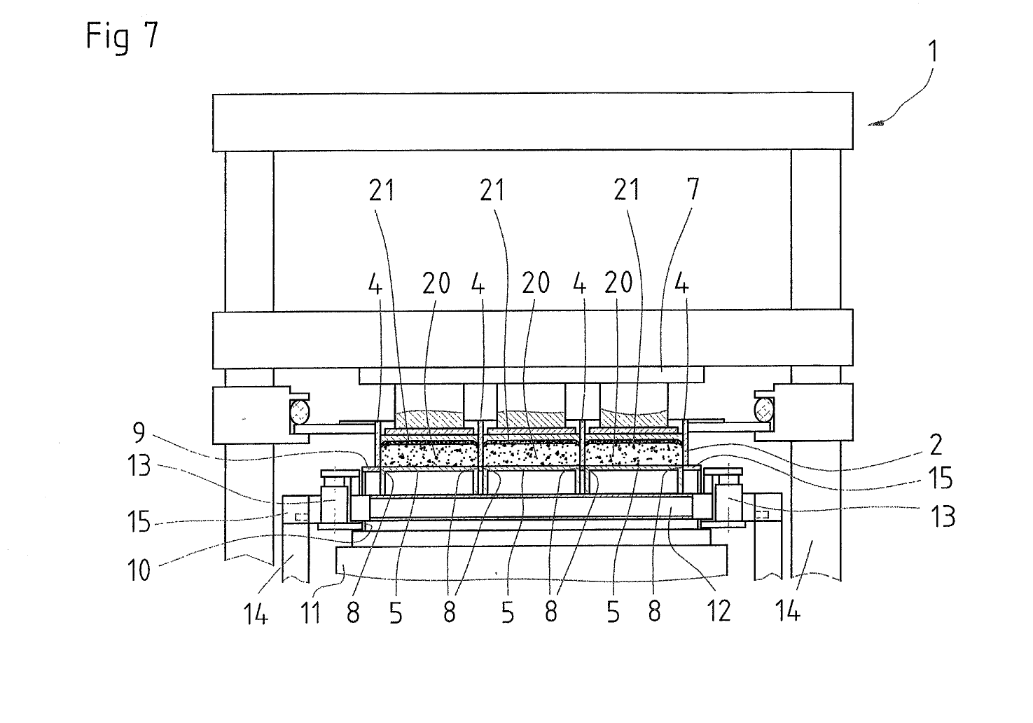

FIG. 7 shows again the vertical position as shown in FIG. 1, but with a lower height of the first material layer 20. In this case the bottom plates 5 are retracted accordingly farther into the mold cavities 3. In this way any desired stone height can be established. In the same way the height of the second material layer 21 can also be varied by changing the immersion depth of the bottom plates 5 into the mold 2 after precompaction of the material layer 20.

The movements of the bottom plates 5, the pressure plates 6 and the mold 2 which are matched to one another according to the desired height of the concrete blocks can be predetermined by the corresponding program controls of a microprocessor so that a fully automatic production sequence is enabled.

It will be understood that this invention is susceptible to modification in order to adapt it to different usages and conditions; and, accordingly, it is desired to comprehend such modifications within this invention as may fall within the scope of appended claims.

What is claimed is:

1. In a process for producing concrete molded blocks having two different layers of material which are placed in a mold cavity of a vertically movable mold having substantially vertical side walls, a top pressure plate which can be moved vertically to close the mold cavity and a vertically movable bottom plate, the steps comprising:
(a) moving the bottom plate upwardly into the mold cavity into a position corresponding to the desired height of the concrete block, locking the bottom plate in such vertical position and adding a first layer of material into the mold,
(b) precompacting the first layer of material between the mold top plate and the mold bottom plate,
(c) filling the mold cavity with a second layer of material,
(d) compacting the first and second layers of material between the mold top plate and the mold bottom plate,
(e) moving the bottom plate horizontally from the mold area and removing the finished concrete block from the mold.

2. The process as claimed in claim 1 wherein after adding the first layer of material moving the bottom plate and first layer downwardly to a height corresponding to the desired thickness of a second layer and moving the top plate downwardly against the first layer.

3. The process as claimed in claim 1 wherein after precompacting raising the top pressure plate to enable the second layer of material to be added to the mold cavity.

4. The process as claimed in claim 1 wherein after adding the second layer of material moving the top pressure plate and bottom plate with the first and second layers therebetween to position the top surface of the bottom plate immediately below the bottom edge of the mold cavity.

5. The process as claimed in claim 1 and the step of moving the bottom plate into a second vertical position only after precompacting of the first layer of material.

6. An apparatus for producing a concrete molded block having two different layers of material comprising a stripper plate having a top surface and means for vibrating said stripper plate, there being an opening in said top surface of said stripper plate, a mold having a mold cavity with substantially vertical side walls and positionable upon the top surface of said stripper plate, means for vertically moving said mold, a top pressure plate movable vertically to close the top of said mold cavity, a bottom plate vertically movable through said opening in said top surface of said stripper plate to close the bottom of said mold cavity.

7. An apparatus as claimed in claim 6 wherein said means for vibrating said stripper plate comprises a vibrating table upon which said stripper plate is supported.

8. An apparatus as claimed in claim 6 and further comprising a vertically movable box disposed below said mold cavity and said stripper plate defining a top surface of said box, said bottom plate mounted on said box extending through the opening in said stripper plate and vertically movable with said box, and means attached to said box by moving said box and the attached bottom plates horizontally out of the area of said mod.

9. An apparatus as claimed in claim 8 and further comprising a vertically movable horizontal support member mounted within said box, said bottom plates mounted on said horizontal support member, and a drive unit mounted on said box and connected to said horizontal support member such as to move said support within said box.

10. An apparatus as claimed in claim 8 and further comprising means for vibrating said box, and means for moving one of said box or stripper plate horizontally and then vertically upwardly a predetermined amount sufficient to enable a frame board to be positioned upon said vibrating table.
